(19) United States
(12) Patent Application Publication
(10) Pub. No.: US 2018/0047056 A1
(43) Pub. Date: Feb. 15, 2018

(54) DISPLAY DEVICE AND CONTROLLING METHOD THEREOF

(71) Applicant: LG ELECTRONICS INC., Seoul (KR)

(72) Inventors: Jayoen KIM, Seoul (KR); Woojin SUH, Seoul (KR); Joohyeon OH, Seoul (KR); Sangin CHUNG, Seoul (KR)

(73) Assignee: LG ELECTRONICS INC., Seoul (KR)

(21) Appl. No.: 15/649,532

(22) Filed: Jul. 13, 2017

(30) Foreign Application Priority Data
Aug. 9, 2016 (KR) 10-2016-0101048

(51) Int. Cl. G06Q 30/02; G06T 7/20; H04N 7/18

(52) U.S. Cl. CPC G06Q 30/0266; H04N 7/185; G06T 7/20; G06T 2207/30196; G06T 2207/30248

(57) ABSTRACT

Disclosed are a display device and operating method thereof. The present invention includes obtaining an image of a vehicle, determining a moving speed of the vehicle based on the obtained image, and outputting an advertising content corresponding to the determined moving speed.

Pursuant to 35 U.S.C. § 119(a), this application claims the benefit of earlier filing date and right of priority to Korean Application No. 10-2016-0101048, filed on Aug. 9, 2016, the contents of which are all hereby incorporated by reference herein in its entirety.

### BACKGROUND OF THE INVENTION

### Field of the Invention

The present invention relates to an electronic device, and more particularly, to a display device and controlling method thereof. Although the present invention is suitable for a wide scope of applications, it is particularly suitable for outputting an advertising content.

### Discussion of the Related Art

Display devices become the means for delivering various kinds of informations beyond outputting contents at home or commercial areas owing to the ongoing developments of the display devices.

For instance, digital signages configured to display information and images on a display screen or a projector screen using the digital technology are frequently seen in various places. The digital signages are classified into an outdoor digital signage installed in an outdoor space and an indoor digital signage installed in an indoor space.

The outdoor digital signage installed on an outer wall or rooftop of a building or a street is being developed in a manner of expanding its functions as an outdoor advertisement medium for displaying real-time news as well as video advertisements. Thus, the advertisement through the outdoor digital signage is popularly used as an advertisement using out-of-home media.

The indoor digital signage installed on an inner wall or passage of a building may be configured by reducing a size of the outdoor digital signage. Or, the outdoor digital signage may provide information interactive with a user by employing a kiosk of a touchscreen type.

However, the digital signage outputs a determined image only. When a fast moving means such as a vehicle passes by the digital signage or a user moves on foot at a slow speed, the digital signage may output the same content without discriminating such cases.

Since the digital signage has limitation put on drawing a person's interest unless outputting fancy effects or images attracting a person's attention, it has a problem of a low advertisement effect.

Therefore, the demand for a method and apparatus for maximizing an effect of an advertisement outputted from a display device such as a digital signage is increasingly rising.

### SUMMARY OF THE INVENTION

Accordingly, embodiments of the present invention are directed to a display device and controlling method thereof that substantially obviate one or more problems due to limitations and disadvantages of the related art.

One object of the present invention is to provide a display device and controlling method thereof, by which a content appropriate for a moving speed of a person currently watching the display device is provided.

Another object of the present invention is to provide a display device and controlling method thereof, by which an advertisement having a content type and information amount appropriate for an advertisement target is provided.

Further object of the present invention is to provide a display device and controlling method thereof, by which an effect of an advertisement outputted through the display device is raised.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a display device according to one embodiment of the present invention may include a display, a camera configured to obtain an image for a vehicle, and a controller configured to determine a moving speed of the vehicle based on the obtained image and control an advertising content corresponding to the determined moving speed to be outputted to the display.

If the determined moving speed is equal to or lower than a first reference speed, the controller may control a video to be outputted to the display.

The controller may control the video having a play time corresponding to the determined moving speed to be outputted to the display.

If the determined moving speed exceeds a second reference speed, the controller may control a still image to be outputted to the display.

If the determined moving speed exceeds a first reference speed and is equal to or lower than a second reference speed, the controller may control an image, in which a prescribed object contained in a still image moves only, to be outputted to the display.

The controller may determine a vehicle type of the vehicle based on the obtained image and control the advertising content corresponding to the determined vehicle type to be outputted to the display.

The controller may determine vehicle traffic based on the obtained image and calculate an advertisement rate for the outputted advertising content based on the determined vehicle traffic.

In another aspect of the present invention, as embodied and broadly described herein, a display device according to another embodiment of the present invention may include a display, a camera configured to obtain an image for a pedestrian, and a controller configured to output a first content to the display, determine whether the pedestrian reacts to the outputted first content based on the obtained image, control a second content to be outputted to the display if determining that the pedestrian reacts to the outputted first content.

Based on the obtained image, if a moving speed of the pedestrian is reduced or the pedestrian stops moving, the controller may determine that the pedestrian reacts to the outputted first content.

The controller may determine a moving direction of the pedestrian based on the obtained image and control a content corresponding to the determined moving direction to be outputted to the display.

In further aspect of the present invention, as embodied and broadly described herein, a method of operating a display device according to one embodiment of the present invention may include obtaining an image for a vehicle, determining a moving speed of the vehicle based on the obtained image, and outputting an advertising content corresponding to the determined moving speed.

The outputting the advertising content corresponding to the determined moving speed may include if the determined moving speed is equal to or lower than a first reference speed, outputting a video.

The outputting the advertising content corresponding to the determined moving speed may include outputting the video having a play time corresponding to the determined moving speed.

The outputting the advertising content corresponding to the determined moving speed may include if the determined moving speed exceeds a second reference speed, outputting a still image.

The outputting the advertising content corresponding to the determined moving speed may include if the determined moving speed exceeds a first reference speed and is equal to or lower than a second reference speed, outputting an image in which a prescribed object contained in a still image moves only.

The method may further include determining a vehicle type of the vehicle based on the obtained image and outputting the advertising content corresponding to the determined vehicle type.

The method may further include determining vehicle traffic based on the obtained image and calculating an advertisement rate for the outputted advertising content based on the determined vehicle traffic.

In another further aspect of the present invention, as embodied and broadly described herein, a method of operating a display device according to another embodiment of the present invention may include obtaining an image for a pedestrian, outputting a first content, determining whether the pedestrian reacts to the outputted first content based on the obtained image, and outputting a second content if determining that the pedestrian reacts to the outputted first content.

The determining whether the pedestrian reacts to the outputted first content may include if a moving speed of the pedestrian is reduced or the pedestrian stops moving based on the obtained image, determining that the pedestrian reacts to the outputted first content.

The method may further include determining a moving direction of the pedestrian based on the obtained image and outputting a content corresponding to the determined moving direction.

Accordingly, embodiments of the present invention provide various effects and/or features.

First of all, a display device according to an embodiment of the present invention can provide a content that can be viewed appropriately by a person currently watching the display device, thereby clearly delivering a message of an advertising content and raising an advertisement effect.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. The above and other aspects, features, and advantages of the present invention will become more apparent upon consideration of the following description of preferred embodiments, taken in conjunction with the accompanying drawing figures.

In the drawings:

FIG. 1 is a block diagram to describe a display device in association with the present invention;

FIG. 2 is a block diagram for the configuration of a display device according to one embodiment of the present invention;

FIG. 3 is a flowchart for a method of operating a display device according to various embodiments of the present invention;

FIG. 4 is a diagram for one example of an image shot for a moving speed determination according to various embodiments of the present invention;

FIG. 5 is a diagram for one example of an image shot for a moving speed determination of bidirectional vehicles according to various embodiments of the present invention;

FIG. 6 is a diagram for one example of a video output according to various embodiments of the present invention;

FIG. 7 is a diagram for one example of an image output containing a motion according to various embodiments of the present invention;

FIG. 8 is a diagram for one example of a still image output according to various embodiments of the present invention;

FIG. 9 is a diagram for one example of a vehicle type determination according to various embodiments of the present invention;

FIG. 10 is a flowchart for a content output operation according to various embodiments of the present invention;

FIG. 11 is a diagram for a content output operation according to various embodiments of the present invention;

FIG. 12 is a flowchart for a content output operation according to various embodiments of the present invention;

FIG. 13 is a diagram for a content output operation according to various embodiments of the present invention;

FIG. 14 is a flowchart for an additional content output operation according to various embodiments of the present invention;

FIG. 15 is a diagram for one example of a viewer determination according to various embodiments of the present invention;

FIG. 16 is a flowchart of a content output operation at a pedestrian rate according to various embodiments of the present invention;

FIG. 17 is a flowchart of a content output operation corresponding to a pedestrian moving direction according to various embodiments of the present invention; and

FIG. 18 and FIG. 19 are diagrams for examples of a content output corresponding to a pedestrian's moving direction according to various embodiments of the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

An electronic device disclosed in the present specification may include a terminal such as a mobile phone, a smartphone, a laptop computer, a digital broadcast terminal, a PDA (personal digital assistants), PMP(portable multimedia player), a navigator, a slate PC, a tablet PC, a ultrabook, a wearable device (e.g., a smartwatch, a smart glass, a head mounted display) (HMD), etc.).

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, digital signage and the like.

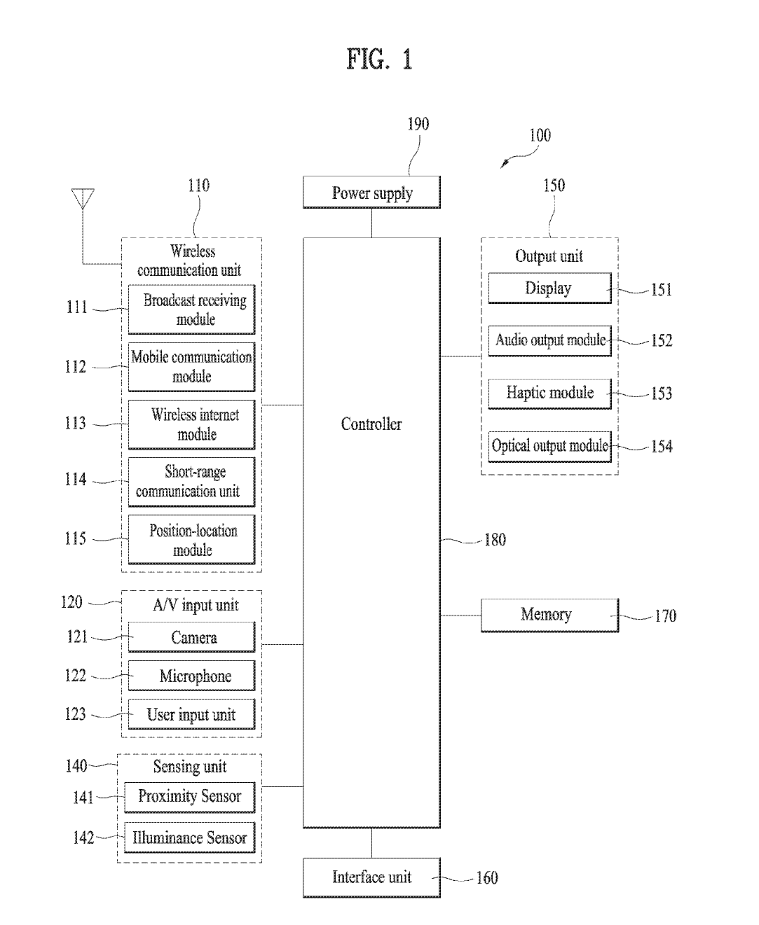

FIG. 1 is a block diagram to describe an electronic device in association with the present invention.

An electronic device 100 may include a wireless communication unit 110, an input unit 120, a sensing unit 140, an output unit 150, an interface unit 160, a memory 170, a controller 180, a power supply unit 190 and the like. As the components shown in FIG. 1 are not mandatory for implementation of the electronic device, the electronic device mentioned in the present specification may have components more or less than the above-listed components.

Particularly, the wireless communication unit 100 among the components may include at least one module capable of enabling a wireless communication between the electronic device 100 and a wireless communication system, between the electronic device 100 and another electronic device, or between the electronic device 100 and an external server. And, the wireless communication unit 110 may include at least one module configured to connect the electronic device 100 to at least one network.

The wireless communication unit 110 may include at least one of a broadcast receiving module 111, a mobile communication module 112, a wireless internet module 113, a short range communication module 114, a location information module 115 and the like.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the electronic device, the surrounding environment of the electronic device, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The electronic device 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the electronic device 100 and a user, as well as function as the user input unit 123 which provides an input interface between the electronic device 100 and the user.

The interface unit 160 serves as an interface with various types of external devices that can be coupled to the electronic device 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the electronic device 100 may perform assorted control functions associated with a connected external device, in response to the external device being connected to the interface unit 160.

The memory 170 is typically implemented to store data to support various functions or features of the electronic device 100. For instance, the memory 170 may be configured to store application programs executed in the electronic device 100, data or instructions for operations of the electronic device 100, and the like. Some of these application programs may be downloaded from an external server via wireless communication. Other application programs may be installed within the electronic device 100 at time of manufacturing or shipping, which is typically the case for basic functions of the electronic device 100 (for example, receiving a call, placing a call, receiving a message, sending a message, and the like). It is common for application programs to be stored in the memory 170, installed in the electronic device 100, and executed by the controller 180 to perform an operation (or function) for the electronic device 100.

The controller 180 typically functions to control overall operation of the electronic device 100, in addition to the operations associated with the application programs. The controller 180 may provide or process information or functions appropriate for a user by processing signals, data, information and the like, which are input or output by the various components depicted in FIG. 1, or activating application programs stored in the memory 170. As one example, the controller 180 controls some or all of the components illustrated in FIG. 1 according to the execution of an application program that have been stored in the memory 170.

The power supply unit 190 can be configured to receive external power or provide internal power in order to supply appropriate power required for operating elements and components included in the electronic device 100. The power supply unit 190 may include a battery, and the battery may be configured to be embedded in the electronic device body, or configured to be detachable from the electronic device body.

At least one portion of the above-mentioned components can cooperatively operate to implement operations, controls or controlling methods of the electronic device according to various embodiments mentioned in the following description. And, the operations, controls or controlling methods of the electronic device can be implemented on the electronic device by running at least one or more application programs saved in the memory 170.

Referring still to FIG. 1, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

system which generates and transmits a broadcast signal and/or broadcast associated information, or a server which receives a pre-generated broadcast signal and/or broadcast associated information, and sends such items to the electronic device. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this case, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external electronic device, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO(Enhanced Voice-Data Optimized or Enhanced Voice-Data Only), Wideband CDMA (WCDMA), High Speed Downlink Packet access (HSDPA), HSUPA(High Speed Uplink Packet Access), Long Term Evolution (LTE), LTE-A(Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the electronic device 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA(High Speed Uplink Packet Access), Long Term Evolution (LTE), LTE-A(Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA,HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTHTM, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB(Wireless Universal Serial Bus), and the like. The short-range communication module 114 in general supports wireless communications between the electronic device 100 and a wireless communication system, communications between the electronic device 100 and another electronic device 100, or communications between the electronic device and a network where another electronic device 100 (or an external server) is located, via wireless area networks. One example of the wireless area networks is a wireless personal area networks.

In some embodiments, another electronic device (which may be configured similarly to electronic device 100) may be a wearable device, for example, a smart watch, a smart glass or a head mounted display (HMD), which is able to exchange data with the electronic device 100 (or otherwise cooperate with the electronic device 100). The short-range communication module 114 may sense or recognize the wearable device, and permit communication between the wearable device and the electronic device 100. In addition, when the sensed wearable device is a device which is authenticated to communicate with the electronic device 100, the controller 180, for example, may cause transmission of data processed in the electronic device 100 to the wearable device via the short-range communication module 114. Hence, a user of the wearable device may use the data processed in the electronic device 100 on the wearable device. For example, when a call is received in the electronic device 100, the user may answer the call using the wearable device. Also, when a message is received in the electronic device 100, the user can check the received message using the wearable device.

The location information module 115 is generally configured to detect, calculate, derive or otherwise identify a position of the electronic device. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the electronic device.

As one example, when the electronic device uses a GPS module, a position of the electronic device may be acquired using a signal sent from a GPS satellite. As another example, when the electronic device uses the Wi-Fi module, a position of the electronic device can be acquired based on information related to a wireless access point (AP) which transmits or receives a wireless signal to or from the Wi-Fi module.

The input unit 120 may be configured to permit various types of input to the electronic device 100. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the electronic device 100. As another example, the cameras 121 may be located in a stereoscopic arrangement to acquire left and right images for implementing a stereoscopic image.

The microphone 122 is generally implemented to permit audio input to the electronic device 100. The audio input can be processed in various manners according to a function being executed in the electronic device 100. If desired, the microphone 122 may include assorted noise removing algorithms to remove unwanted noise generated in the course of receiving the external audio.

The user input unit 123 is a component that permits input by a user. Such user input may enable the controller 180 to control operation of the electronic device 100. The user input unit 123 may include one or more of a mechanical input element (for example, a key, a button located on a front and/or rear surface or a side surface of the electronic device 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the electronic device at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the electronic device, surrounding environment information of the electronic device, user information, or the like. The controller 180 generally cooperates with the sending unit 140 to control operation of the electronic device 100 or execute data processing, a function or an operation associated with an application program installed in the electronic device based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the electronic device covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the electronic device 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the electronic device 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the electronic device 100. For example, the display unit 151 may display execution screen information of an application program executing at the electronic device 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the electronic device 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the electronic device 100.

An optical output module 154 can output a signal for indicating an event generation using light of a light source. Examples of events generated in the electronic device 100 may include message reception, call signal reception, a missed call, an alarm, a schedule notice, an email reception, information reception through an application, and the like.

A signal output by the optical output module 154 may be implemented in such a manner that the electronic device emits monochromatic light or light with a plurality of colors. The signal output may be terminated as the electronic device senses that a user has checked the generated event, for example.

The interface unit 160 serves as an interface for external devices to be connected with the electronic device 100. For example, the interface unit 160 can receive data transmitted from an external device, receive power to transfer to elements and components within the electronic device 100, or transmit internal data of the electronic device 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the electronic device 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the electronic device 100 via the interface unit 160.

When the electronic device 100 is connected with an external cradle, the interface unit 160 can serve as a passage to allow power from the cradle to be supplied to the electronic device 100 or may serve as a passage to allow various command signals input by the user from the cradle to be transferred to the electronic device there through. Various command signals or power input from the cradle may operate as signals for recognizing that the electronic device is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The electronic device 100 may also be operated in relation to a network storage device that performs the storage function of the memory 170 over a network, such as the Internet.

The controller 180 may typically control the general operations of the electronic device 100. For example, the controller 180 may set or release a lock state for restricting a user from inputting a control command with respect to applications when a status of the electronic device meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the electronic device 100. The power supply unit 190 may include a battery, which is typically rechargeable or be detachably coupled to the electronic device body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

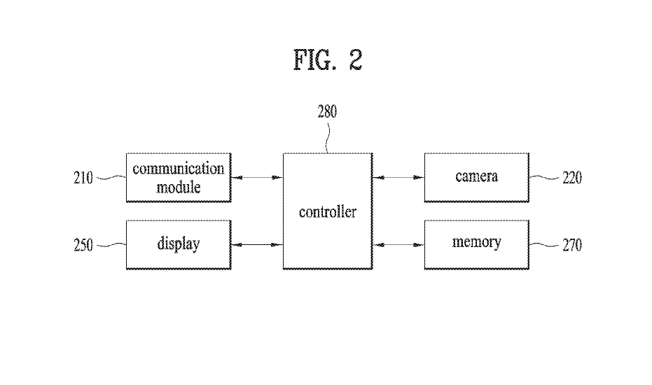

An electronic device 100 according to various embodiments of the present invention may include a display device 200 configured to output contents. The display device 200 may include the aforementioned electronic device 100 or some components of the electronic device 100. The display device 200 may further include components other than the components included in the electronic device 100. A configuration of the display device 200 is described with reference to FIG. 2 as follows.

FIG. 2 is a block diagram for the configuration of a display device according to one embodiment of the present invention.

Referring to FIG. 2, a display device 200 may include a communication module 210, a camera 220, a display 250, a memory 280 and a controller 280. The display device 200 may have components more or less than the above-listed components if necessary.

The communication module 210 may include at least one module capable of enabling a wireless communication between the display device 200 and another electronic device 100, between the display device 200 and an external server. And, the communication module 210 may include at least one module configured to connect the display device 200 to at least one network. For instance, the communication module 210 may include at least one module connecting to a network through a wireless communication or at least one module connecting to a network through a wired communication. The communication module 210 may correspond to the aforementioned wireless communication unit 110.

The camera 200 can capture an image. The camera 220 may include one or more cameras and may obtain an image in one direction or an image in two directions by being provided to one side or both sides of the display device 200. For instance, the camera 220 may obtain an image of target person (e.g., pedestrian) who watches a content outputted from the display device 200 or an image of a person (e.g., pedestrian) corresponding to an advertisement target. And, the camera 220 may obtain an image of a vehicle in which the watching target or the advertisement target is on board. Moreover, the camera 220 may correspond to the aforementioned camera 121.

The display 250 may display (or output) information processed by the display device 200. For instance, the display 250 may output various contents, e.g., a still image, an image having a partial region move therein, a video (e.g., moving images), etc.

As the display 250 may include a plurality of displays, a plurality of the displays may be provided to the display device 200. For instance, a plurality of the displays 250 may be disposed on one side and back side of the display device 200, respectively. At least one of a plurality of the displays disposed on the one side and the back side is turned on only so as to display information or contents.

The memory 270 stores data supportive of various functions of the display device 200. The memory 270 may be configured to store multiple application programs (or applications) run in the display device 200, data and instructions for operations of the display device 200, and the like. Some of these application programs may be downloaded from an external server via wireless/wired communication. Other application programs may be installed within the display device 200 at time of manufacturing or shipping, which is typically the case for basic functions of the display device 200 (for example, information display function, content output function, etc.). It is common for application programs to be stored in the memory 270, installed on the display device 200, and launched by the controller 280 to perform an operation (or function) of the electronic device. And, the memory 270 may further store content data of a content outputted from the display device 200. The content may be downloaded from an external server or device through wireless/wired communication, or may be downloaded through an interface provided to the display device 200. The memory 270 may correspond to the aforementioned memory 170.

The controller 280 typically functions to control overall operation of the display device 200, in addition to the operations associated with the application programs. The controller 280 may provide or process information or functions appropriate for a user by processing signals, data, information and the like, which are input or output by the various components mentioned in the foregoing description, or launching application programs stored in the memory 270. Detailed operations of the controller 280 shall be described later.

First of all, described in the following is a case of an outdoor digital signage having the display device 200 installed on an outdoor place such as an outer wall or rooftop of a building, a road side or the like. Hence, the display device 200 mentioned in the following may include an outdoor digital signage that targets a person boarding a moving means (e.g., vehicle, train, ship, etc.) as a watching target or an advertisement target. Furthermore, the present invention is applicable to a display device 200 like an indoor digital signage installed at an indoor place according to necessity or application as well as to a display device 200 like an outdoor digital signage installed at an outdoor place.

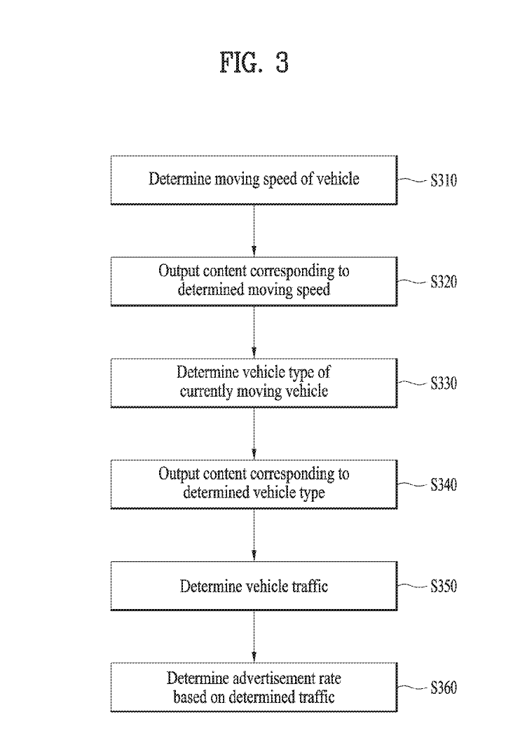

FIG. 3 is a flowchart for an operation of a display device according to various embodiments of the present invention.

Referring to FIG. 3, the display device 200 may determine a moving speed of a vehicle in which an advertisement target is on board [S310].

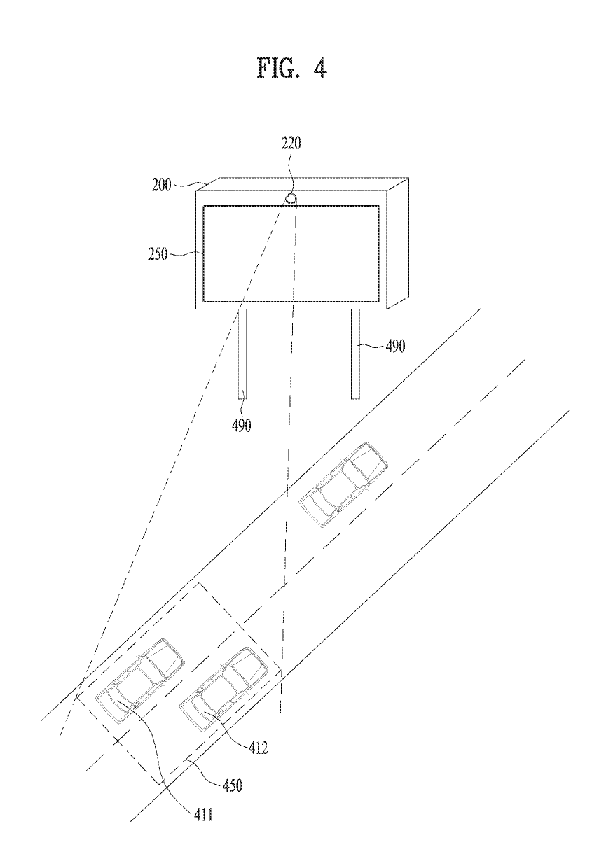

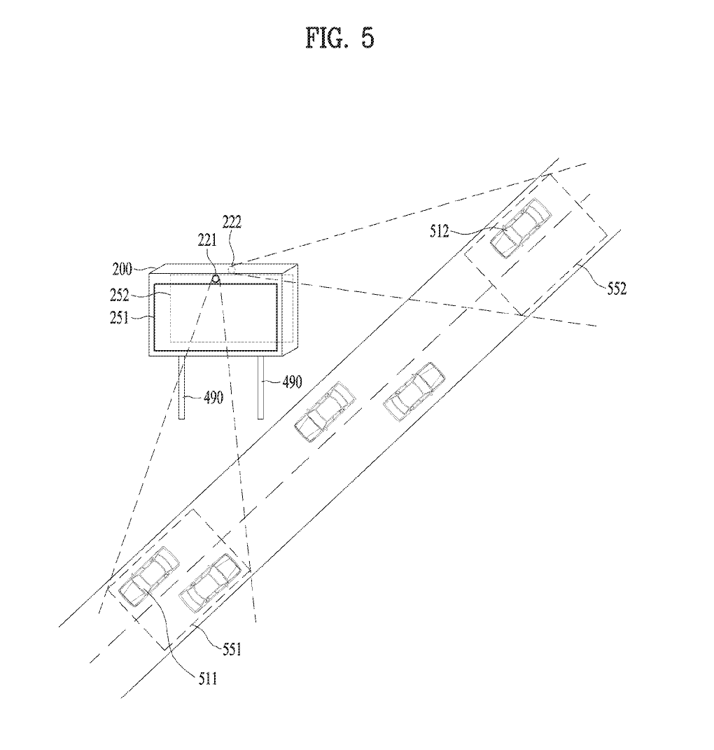

The camera 220 of the display device 200 can capture an image of the vehicle in which the advertisement target is on board. Based on the captured image, the controller 280 can determine the moving speed of the vehicle. For instance, based on the variation of the vehicle passing through a specific zone in the captured image, the controller 280 can determine the moving speed of the vehicle. For one example, based on the captured image, the controller 280 can determine an averaged moving speed of a plurality of vehicles passing through the specific zone. This is described with reference to FIG. 4 and FIG. 5 as follows.

FIG. 4 is a diagram for one example of an image shot for a moving speed determination according to various embodiments of the present invention.

Referring to FIG. 4, the display device 200 may be located at a road side and supported by a support 490. The camera 220 can capture an image of a vehicle moving toward the display device 200. For one example, the camera 220 can capture an image of a specific zone (hereinafter named ‘shot zone’) spaced apart from the display device 200 in a predetermined distance. Hence, the camera 220 can obtain an image for vehicles passing through the shot zone 450. For instance, the camera 220 can obtain an image for first and second vehicles 411 and 412 that are the vehicles passing through the shot zone 450. Based on the obtained image, the controller 280 can determine moving speeds of the first and second vehicles 411 and 412. Based on the determined moving speeds of the vehicles determined on the basis of the images obtained for the shot zone 450, the controller 280 can determine the averaged moving speed of the vehicles passing through the shot zone 450.

FIG. 5 is a diagram for one example of an image shot for a moving speed determination of bidirectional vehicles according to various embodiments of the present invention.

Referring to FIG. 5, the display device 200 may be located at a road side and supported by a support 490. The display device 200 may include a plurality of cameras 211 and 212 and a plurality of displays 251 and 252, disposed in different directions, respectively.

The first camera 221 may obtain an image for a vehicle moving in one direction. For instance, the first camera 221 may obtain an image for a specific zone (hereinafter named ‘first shot zone’) spaced apart from the display device 200 in a predetermined distance. Hence, the first camera 221 may obtain an image for vehicles passing through the first shot zone 551. For instance, the first camera 221 may obtain an image for a first vehicle 511 corresponding to a vehicle passing through the first shot zone 551. Based on the obtained image, the controller 280 may determine a moving speed of the first vehicle 511. Based on the moving speeds of the vehicles determined from the obtained images for the first shot zone 551, the controller 280 may determine an averaged moving speed of the vehicles passing through the first shot zone 551. Based on the determined averaged moving speed of the vehicles, the controller 280 may output a content to the first display 251. This shall be described later.

The second camera 222 may obtain an image for a vehicle moving in one direction. For instance, the second camera 222 may obtain an image for a specific zone (hereinafter named ‘second shot zone’) spaced apart from the display device 200 in a predetermined distance. Hence, the second camera 222 may obtain an image for vehicles passing through the second shot zone 552. For instance, the second camera 222 may obtain an image for a second vehicle 512 corresponding to a vehicle passing through the second shot zone 552. Based on the obtained image, the controller 280 may determine a moving speed of the second vehicle 512. Based on the moving speeds of the vehicles determined from the obtained images for the second shot zone 552, the controller 280 may determine an averaged moving speed of the vehicles passing through the second shot zone 552. Based on the determined averaged moving speed of the vehicles, the controller 280 may output a content to the second display 252. This shall be described later.

Meanwhile, although various embodiments in the following are described centering on a display device 200 having a single camera 220 and a single display 250, as mentioned in the foregoing description, they can be implemented with a display device having a plurality of cameras and a plurality of displays.

FIG. 3 is referred to again.

The display device 200 may output a content corresponding to the determined moving speed [S320].

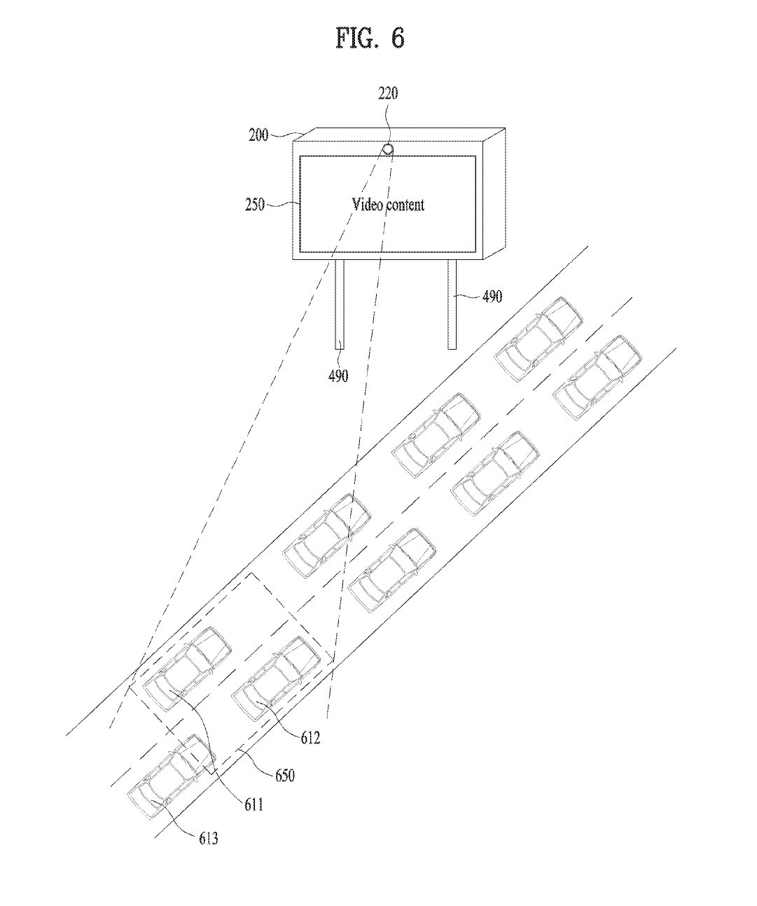

The controller 280 of the display device 200 may output a content corresponding to the determined moving speed (e.g., an averaged moving speed) to the display 250. For instance, if the determined moving speed is lower than a reference speed, the controller 280 may output a content of a video. If the determined moving speed is higher than the reference speed, the controller 280 may output a content of a still image. For another instance, the controller 280 may output various contents such as a video, a still image, an image having a partial region move only, and the like according to the determined moving speed. This shall be described with reference to FIGS. 6 to 8.

FIG. 6 is a diagram for one example of a video output according to various embodiments of the present invention.

Referring to FIG. 6, the display device 200 may determine a moving speed of a vehicle moving in a direction toward the display device 200. For instance, the camera 220 may capture an image for a shot zone 650. Based on the captured image, the controller 280 may determine moving speeds of first to third vehicles 611 to 613 passing through the shot zone 650, respectively. And, the controller 280 may determine an averaged moving speed of the vehicles passing through the shot zone 650. If the determined averaged moving speed is equal to or lower than a first reference speed, the controller 280 may output an advertising content of a video to the display 250. In doing so, as the first reference speed is a low speed with respect to a vehicle movement, a road including the shot zone 650 may be congested. For instance, the first reference speed may be 10 km/h. Hence, the display device 200 can output an advertising content corresponding to a video, which is a content having considerable motions or variations of an object contained in the content, toward the vehicles on the congested road. Hence, the display device 200 can draw attentions of persons in the vehicles moving at a considerably low speed and may provide the persons with the advertisement of the content capable of delivering a considerable content amount effectively. Thus, the display device 200 may provide a video having a good advertisement effect to the persons in the vehicle moving at a considerably low speed.

Moreover, the display device 200 may adjust or select a play length of a video outputted based on a determined moving speed of a vehicle. For instance, based on the determined moving speed, the display device 200 may calculate a time for the vehicle, which passes by the display device 200, to watch the outputted video and output an advertisement video of a play length corresponding to the calculated time to the display 250. For one example, based on a determined moving speed of a vehicle, if the display device 200 determines that a time for the moving vehicle to watch the display device 200 is 20 seconds, it can output an advertisement video of 20 seconds to the display 250.

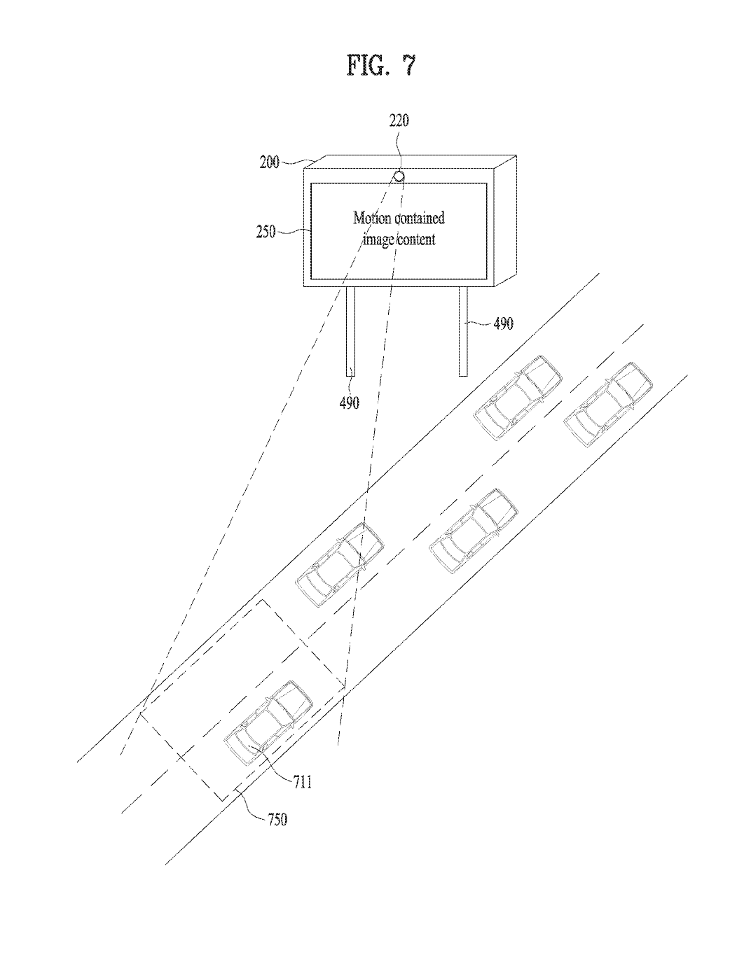

FIG. 7 is a diagram for one example of an image output containing a motion according to various embodiments of the present invention.

Referring to FIG. 7, the display device 200 may determine a moving speed of a vehicle moving in a direction toward the display device 200. For instance, the camera 220 may capture an image for a shot zone 750. Based on the captured image, the controller 280 may determine a moving speed of a first vehicle 711 passing through the shot zone 750. And, the controller 280 may determine an averaged moving speed of vehicles passing through the shot zone 750. If the determined averaged moving speed exceeds a first reference speed and is equal to or lower than a second reference speed, the controller 280 may output an advertising content (e.g., a motion contained image) to the display 250. In this case, the second reference speed may include a slow speed of a vehicle, e.g., 20 km/h. For example, if the determined averaged moving speed exceeds 10 km/h and equal to or lower than 20 km/h, an advertising content, which is the motion contained image, can be outputted to the display 250. Hence, the display device 200 can output the advertising content, which is configured with a motion contained image corresponding to a content having a small motion or variation of an object included in the content, toward the vehicle moving slow. In this case, the motion contained image content may mean a video having a small motion or variation of an object. Hence, the display device 200 may draw attentions of persons in the slow-moving vehicle and provide an advertising content causing not distraction to the driving. Thus, the display device 200 can provide the persons in the slot-moving vehicle with an image or video, in which some objects move only, corresponding to a content having a good advertisement effect.

Moreover, the display device 200 may adjust or select a motion contained in the outputted image or video based on a determined moving speed of a vehicle. For instance, based on the determined moving speed, the display device 200 may calculate a time for the vehicle, which passes by the display device 200, to watch the outputted video and then output an advertisement image having an information size corresponding to the calculated time to the display 250. In this case, the information size may mean a size of an advertisement message configured with texts, objects and the like contained in the image. Hence, an advertisement image having a large information size may have a long time taken for persons to check the advertisement image. And, an advertisement image having a small information size may have a short time taken for persons to check the advertisement image.

For one example, based on a determined moving speed of a vehicle, if the display device 200 determines that a time for the moving vehicle to watch the display device 200 is 5 seconds, it can output an image containing a content and/or object motion of an information size requiring a check time of about 5 seconds to the display 250.

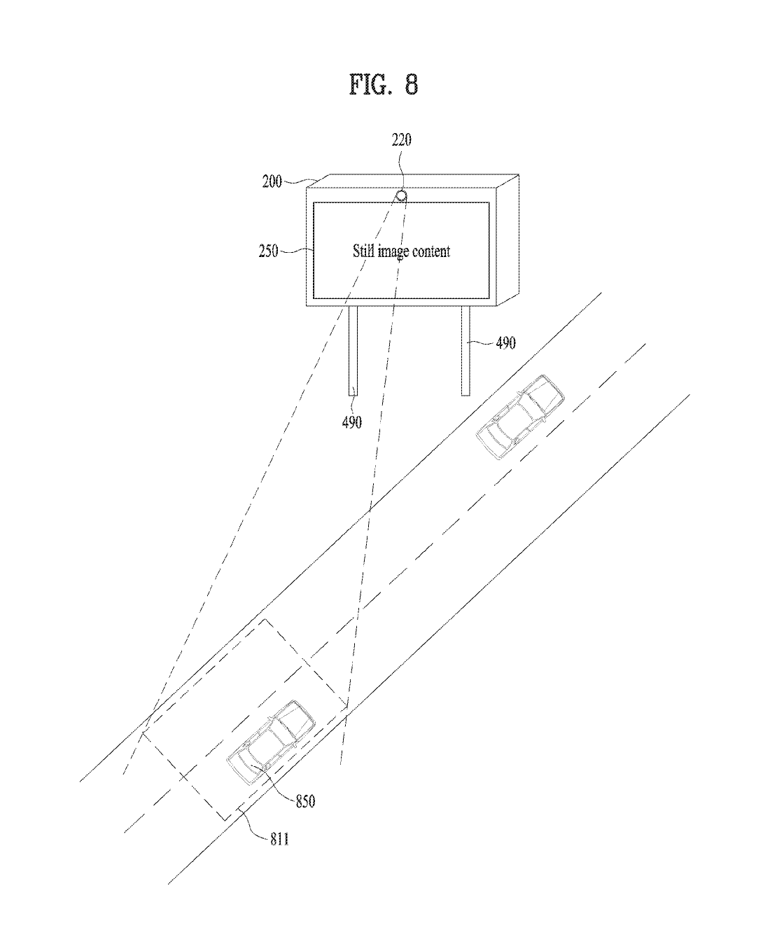

FIG. 8 is a diagram for one example of a still image output according to various embodiments of the present invention.

Referring to FIG. 8, the display device 200 may determine a moving speed of a vehicle moving in a direction toward the display device 200. For instance, the camera 220 may capture an image for a shot zone 850. Based on the captured image, the controller 280 may determine a moving speed of a first vehicle 811 passing through the shot zone 850. And, the controller 280 may determine an averaged moving speed of vehicles passing through the shot zone 850. If the determined averaged moving speed exceeds a second reference speed, the controller 280 may output an advertising content (e.g., a still image) to the display 250. For example, if the determined averaged moving speed exceeds 20 km/h, an advertising content, which is a still image, can be outputted to the display 250. Hence, the display device 200 can output the advertising content, which is configured with still image, toward persons in a currently traveling vehicle. Thus, the display device 200 may draw attentions of the persons in the currently traveling vehicle and provide an advertising content causing no distraction to the driving. Therefore, the display device 200 can provide the persons in the traveling vehicle with an advertising content configured with an image having a good advertisement effect.

Moreover, the display device 200 may adjust or select an amount of a content or object contained in the outputted image based on a determined moving speed of a vehicle. For instance, based on the determined moving speed, the display device 200 may calculate a time for the vehicle, which passes by the display device 200, to watch the outputted video and then output an advertisement image having an information size corresponding to the calculated time to the display 250. For one example, based on a determined moving speed of a vehicle, if the display device 200 determines that a time for the moving vehicle to watch the display device 200 is 1 second, it can output an image containing a content and/or object having an information size of about 1 second to the display 250.

As mentioned in the foregoing description, the display device 200 can output a content corresponding to a moving speed of a vehicle in which a watching target or an advertisement target is inside, thereby providing persons with an advertising content of a most efficient type. Thus, the display device 200 according to various embodiments of the present invention can increase an advertisement effect. And, the display device 200 can be effective to a safety problem of vehicle driver's distraction that may be caused by a content outputted from the display device 200. Therefore, display device 200 according to various embodiments of the present invention may help accident danger to decrease.

FIG. 3 is referred to again.

The display device 200 can determine a vehicle type of the currently moving vehicle [S330].

Based on the image taken through the camera 220, the controller 280 of the display device 200 can determine a vehicle type of the vehicle moving in the display device direction. In particular, the vehicle type may include detailed information such as a vehicle manufacturer, a vehicle model name and the like as well as a type of a vehicle sorted by a vehicle size, the number of passengers, a carrying capacity and the like.

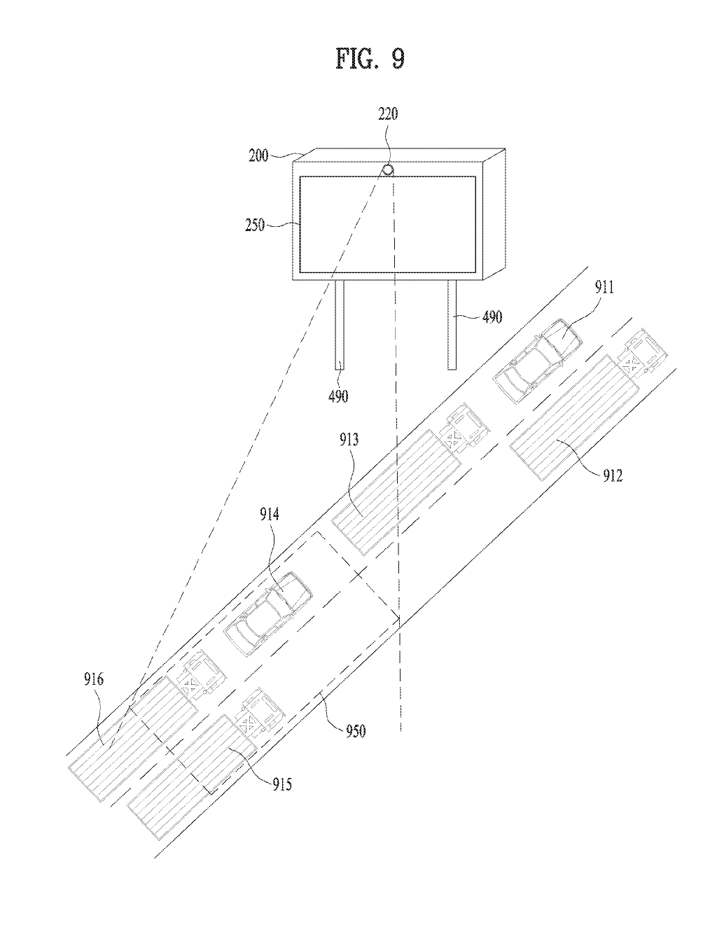

For one example, the controller 290 can obtain an image of a vehicle passing through a shot zone from the camera 220, and may determine a vehicle type of the vehicle based on the obtained image. And, the controller 280 may determine an averaged vehicle type of vehicles passing through the shot zone for a predetermined time, e.g., a vehicle type of the vehicles having passed most frequently. This is described with reference to FIG. 9.

FIG. 9 is a diagram for one example of a vehicle type determination according to various embodiments of the present invention.

Referring to FIG. 9, the camera 220 of the display device 200 may obtain an image for a shot region 950. Based on the obtained image, the controller 280 can determine vehicle types of fourth to sixth vehicles 914 to 916, respectively. In such a manner, the controller 280 may determine vehicle types of first to third vehicles 911 to 913 having passed through the shot zone 950, respectively. Based on the determined vehicle types, the controller 280 can determine an averaged vehicle type of the vehicles passing by the display device 200. For instance, if the first vehicle 911 and the fourth vehicle 914 are cars and the second vehicle 912, the third vehicle 913, the fifth vehicle 915 and the sixth vehicle 916 are trucks, the controller 280 may determine that the averaged vehicle type is a truck.

The above description of the vehicle type determination is one example for description. And, the display device 200 may make the determination according to various references in response to user's or designer's selection. Accordingly, the display device 200 may discriminate a detailed vehicle type such as a manufacturer or a model name as well as a vehicle type according to a usage or size of a vehicle.

FIG. 3 is referred to again.

The display device 200 can output a content corresponding to the determine vehicle type [S340].

The controller 280 of the display device 200 may output a content corresponding to the determined vehicle type (e.g., an averaged vehicle type) to the display 250. In particular, the controller 180 can output an advertising content targeting a driver and passenger(s) of the determined vehicle type to the display 250. For one example, the controller 280 can obtain information on an advertisement target or item according to the determined vehicle type from the memory 270 or an external server (not shown) and is then able to output a content corresponding to the determined vehicle type based on the obtained information.

For instance, if the averaged vehicle type is a car, the controller 280 can output an advertising content targeting a car driver and passengers to the display 250. For another instance, if the averaged vehicle type is a truck, the controller 280 can output an advertising content targeting a truck driver and passengers to the display 250. Hence, the display device 200 can output an advertising content according to a determined vehicle type, thereby raising an advertisement effect.

The display device 200 determines traffic of vehicles [S350], and may calculate an advertisement rate based on the determined traffic [S360].

The display device 200 may determine the vehicle traffic when a specific advertising content is outputted and then calculate an advertisement rate based on the determined traffic. In particular, based on the image obtained through the camera 220, the controller 280 can determine vehicle traffic on outputting a specific advertising content. Then, the controller 280 may calculate an advertisement rate based on the determined vehicle traffic. For instance, if the determined vehicle traffic is heavy, the controller 280 may calculate a high advertisement rate. And, if the determined vehicle traffic is light, the controller 280 may calculate a low advertisement rate. Moreover, the controller 280 may calculate an advertisement rate by further considering an advertisement outputted time as well as the determined vehicle traffic.

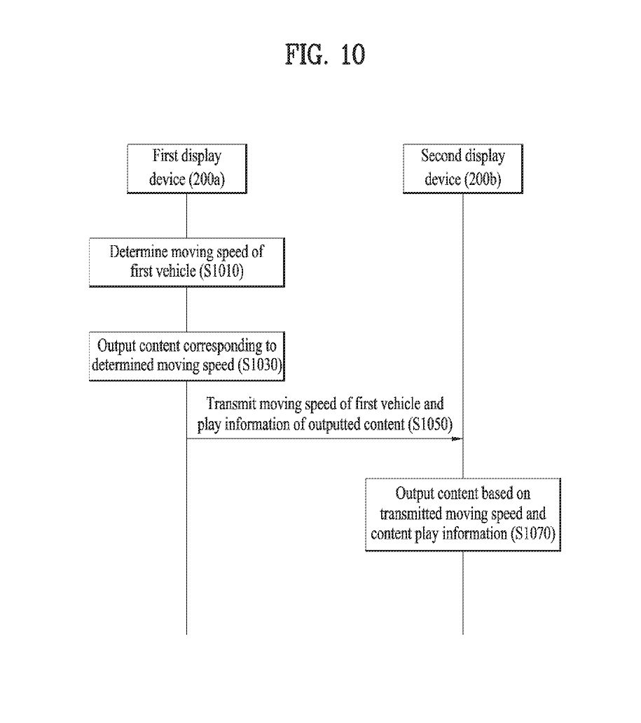

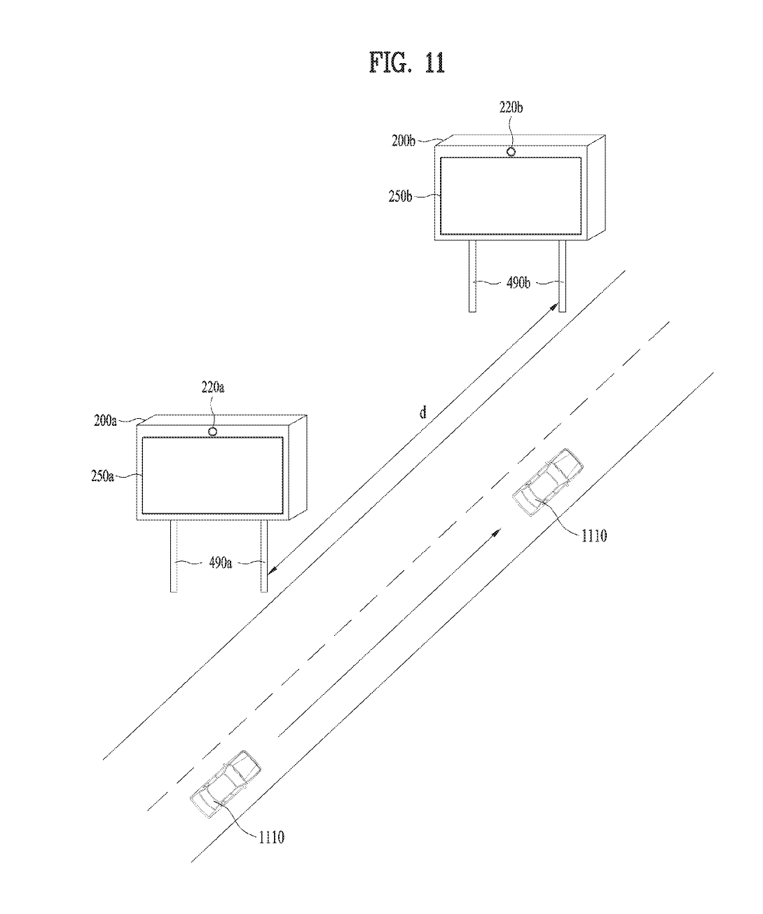

The display device 200 according to various embodiments of the present invention may interwork with another display device 200 in a remote distance. Hence, a next matter of a content outputted from one display device 200 may be outputted from another display device 200 in a progress direction. This is described with reference to FIG. 10 and FIG. 11.

FIG. 10 is a flowchart for a content output operation according to various embodiments of the present invention.

FIG. 11 is a diagram for a content output operation according to various embodiments of the present invention.

Referring to FIG. 10, a first display device 200a may determine a moving speed of a first vehicle moving in a direction of the first display device 200a [S1010]. The first display device 200a may output a content corresponding to the determined moving speed [S1030].

For instance, referring to FIG. 11, a first camera 200a of the first display device 200a may obtain an image for the first vehicle 1110. A controller 200a of the first display device 200a may determine a moving speed of the first vehicle 1110 based on the obtained image. And, the controller 200a may output a content corresponding to the determined moving speed to a first display 250a. This is mentioned in the foregoing description, and its details shall be omitted.

Referring now to FIG. 10, the first display device 200a may transmit the moving speed of the first vehicle and an outputted content play information to a second display 200b [S1050].

The controller 200a of the first display device 200a can transmit the determined moving speed of the first vehicle 1110 and the play information of the content outputted through the first display 250a to the second display device 200b. In this case, the content play information may include information on at least one of a type, substance and play section of the played content.

Based on the transmitted moving speed and content play information, the second display device 200b may output a content [S1070].

Based on the transmitted moving speed and content play information, the controller 280b of the second display device 200b may output the content to the second display 250b. For instance, the controller 280b may output a next substance or a related substance of the content previously watched by a passenger of the first vehicle 110 through the first display 250a to the second display 250b.

Particularly, referring to FIG. 11, based on the moving speed of the first vehicle 1110 and a distance d between the first display device 200a and the second display device 200b, the controller 280b may determine a timing point at which the first vehicle 1110 arrives at the second display device 200b. And, the controller 280b may output a next substance of the content previously outputted from the first display 250a or a content of a next section to the second display 250b at the determined timing point. Hence, persons inside the first vehicle 1110 may watch the next or related substance of the content, which was previously outputted from the first display device 200a, on the second display device 200b continuously.

Meanwhile, the second display device 200b may determine a moving sped of the first vehicle 1110 based on an image captured by a second camera 220b and then output a content to the second display 250b in further consideration of the determined moving speed.

In the following, described is a case of an indoor digital signage having the display device 200 installed at an indoor place such as an inner wall or passage of a building. Hence, the display device 200 mentioned in the following may include an indoor digital signage that targets a person (e.g., a pedestrian, etc.) as a watching target or an advertisement target. Furthermore, the present invention is applicable to a display device 200 like an outdoor digital signage installed at an outdoor place according to necessity or application as well as to a display device 200 like an indoor digital signage installed at an indoor place.

The display device 200 according to various embodiments may output an addition information or a content of an extended substance if there is a person reacting to a currently outputted content. Herein, the person reacting to the content may mean a person who reduces a moving speed or stops to watch the currently outputted content or a person who makes an act or gesture induced by the currently outputted content.

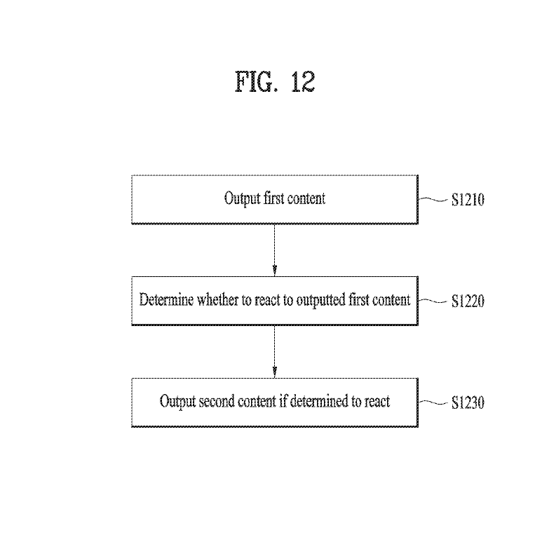

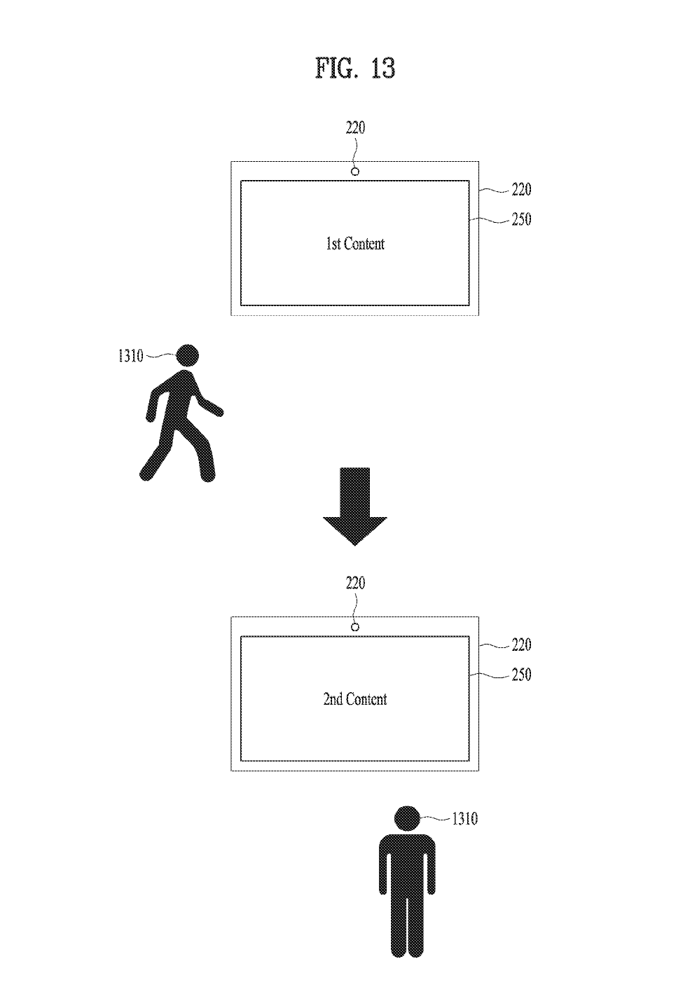

This is described with reference to FIG. 12 and FIG. 13.

FIG. 12 is a flowchart for a content output operation according to various embodiments of the present invention.

Referring to FIG. 12, the display device 200 may output a first content [S1210].

The controller 280 of the display device 200 may output a first content to the display 250. The first content may include a content for inducing pedestrian's eyes. For instance, the first content may include a content containing fancy colors, high brightness and a lot of motions.

The display device 200 may determine whether at least one pedestrian reacts to the outputted first content [S1220].

Based on a captured image of a pedestrian, the controller 280 of the display device 200 may determine whether the pedestrian reacts to the outputted first content.

For one example, based on a moving speed of a currently moving pedestrian, the controller may determine that the currently moving pedestrian reacts to the outputted first content if the corresponding pedestrian reduces the moving speed or stops after the first content output.

For another example, if a pedestrian makes an act or gesture induced by the outputted first content, the controller 280 may determine that the pedestrian reacts to the outputted first content.

For another example, the controller 280 determines currently moving pedestrian's eyes. If the pedestrian's eyes stay over the first content over a predetermined time, the controller 280 may determine that the pedestrian reacts to the outputted first content.

For further example, if a currently moving pedestrian enters a range of a predetermined distance from the display device 200, the controller 280 may determine that the pedestrian reacts to the outputted first content.

If the controller 280 determines that the pedestrian reacts, the display device 200 may output a second content [S1230].

If the controller 280 of the display device 200 determines that the pedestrian reacts to the outputted second content, it can output the second content to the display 250. Herein, the second content may include an advertising content containing details.

Accordingly, the display device 200 induces pedestrian's interest. If the pedestrian reacts, the display device 200 can output an advertising content. Therefore, an advertisement effect on the pedestrian can be improved.

A detailed embodiment is described with reference to FIG. 13.

FIG. 13 is a diagram for a content output operation according to various embodiments of the present invention.

Referring to FIG. 13, when a pedestrian 1310 passes by the display device 200, the display device 200 may output a first content to the display 250. For instance, the display device 200 may output the first content for inducing eyes of the pedestrian 1310 to the display 250. The camera 220 of the display device 200 may capture an image for the pedestrian 1310. Based on the captured image, the controller 280 may determine that the pedestrian 1310 reacts to the outputted first content. For instance, based on the captured image, the controller 280 may determine whether the currently moving pedestrian 1310 stops in a predetermined distance from the display device 200. If the pedestrian stops, the controller 280 may determine that the pedestrian reacts to the outputted first content. If the controller 280 determines that the pedestrian reacts, the display device 200 may output a second content to the display 250. Herein, the second content may include an advertising content, and more particularly, an advertising content containing details. Hence, the display device 200 may induce eyes or interest of the moving pedestrian 1310 and output the second content that is the advertising content.

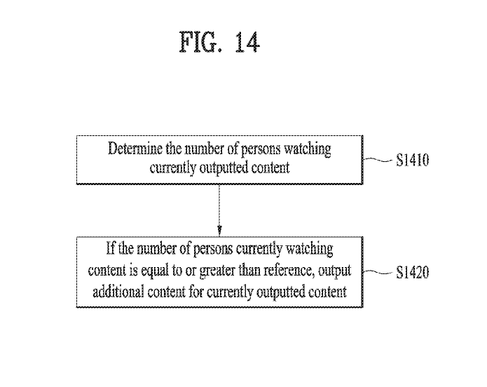

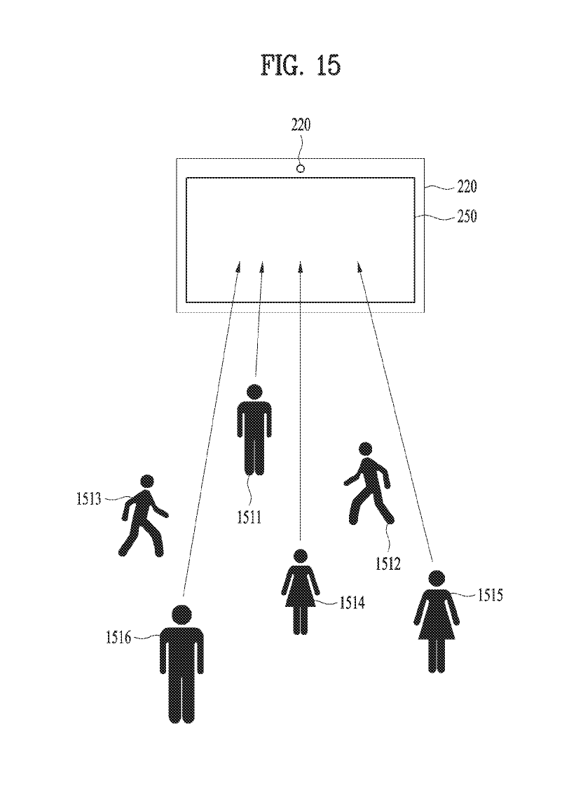

The display device 200 according to various embodiments of the present invention may determine the number of persons watching a currently outputted content. If the number of the persons is equal to or greater than a predetermined number, the display device 200 may output an additional content. This is described with reference to FIG. 14 and FIG. 15.

FIG. 14 is a flowchart for an additional content output operation according to various embodiments of the present invention.

Referring to FIG. 14, the display device 200 may determine the number of persons watching a currently outputted content [S1410].

The camera 220 of the display device 200 may obtains an image for persons near the display device 200. Based on the obtained image, the controller 280 may determine the person(s) watching a content currently outputted from the display device 200 and also determine the number of the watching persons. Particularly, the controller 280 may determine the persons looking at the display 250 of the display device 200 from the obtained image and also determine the number of the determined persons. A detailed embodiment is described with reference to FIG. 15.

FIG. 15 is a diagram for one example of a viewer determination according to various embodiments of the present invention.

Referring to FIG. 15, the camera 220 of the display device 200 may obtain an image for persons near the display device 200. For instance, the camera 220 may obtain an image for first to sixth pedestrians 1511 to 1566. Based on the obtained image, the controller 280 may determine a person looking at the display 250 of the display device 200. For instance, the controller 280 may determine eyes of pedestrians based on the obtained image. If the determined eyes face the display 250, the controller 280 may determine that the display device 200 is watched. For one example, based on the obtained image, the controller 280 may determine that the eyes of each of the first pedestrian 1511, the fourth pedestrian 1514, the fifth pedestrian 1515 and the sixth pedestrian 1516 face the display 250. And, the controller 280 may determine that the second pedestrian 1512 and the third pedestrian 1513 are moving without watching the display device 200.

FIG. 14 is referred to again.

If the number of the persons currently watching the content is equal to or greater than a reference, the display device 200 may output an additional content for the currently outputted content [S1420].

If the number of the persons currently watching the content is equal to or greater than the reference, the controller 280 may output an additional content containing details of the currently outputted content. Herein, the additional content may include a content having substance (e.g., information size) more than that of a previously outputted content or a content having a play time longer than that of a previously outputted content. Meanwhile, if the number of the persons currently watching the content over the total number of the persons near the display device 200 is equal to or greater than a predetermined rate, the controller 280 may output an additional content containing details of the currently outputted content to the display 250. Thus, the display device 200 can provide a detailed advertising content for an advertising content the pedestrians are interested in, thereby raising an advertisement efficiency.

On the other hand, the display device 200 may output a content based on the number of persons stopping near the display device 200, the number of moving persons near the display device, or a rate between the stopping persons and the moving persons as well as the number of persons currently watching the display device 200.

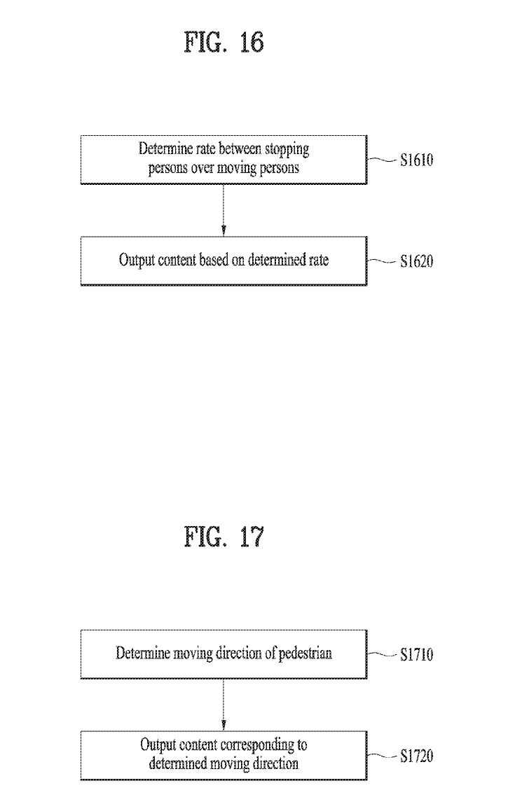

FIG. 16 is a flowchart of a content output operation at a pedestrian rate according to various embodiments of the present invention.

Referring to FIG. 16, the display device 200 may determine a rate between persons stopping near the display device and persons moving near the display device [S1610].

For instance, based on an image obtained through the camera 220, the controller 280 may determine a person stopping near the display device and a person moving near the display device and also determine a rate between the stopping persons and the moving persons.

Based on the determined rate, the display device 200 may output a content [S1620].

Based on the determined rate, the controller 280 may output a content to the display 250. For instance, if the rate of the stopping persons is higher, the controller 280 may output an advertising content of a video. If the rate of the moving persons is higher, the controller 280 may output an advertising content of a still image. Hence, the display device 200 provides a content appropriate for persons near the display device, thereby raising an advertisement effect.

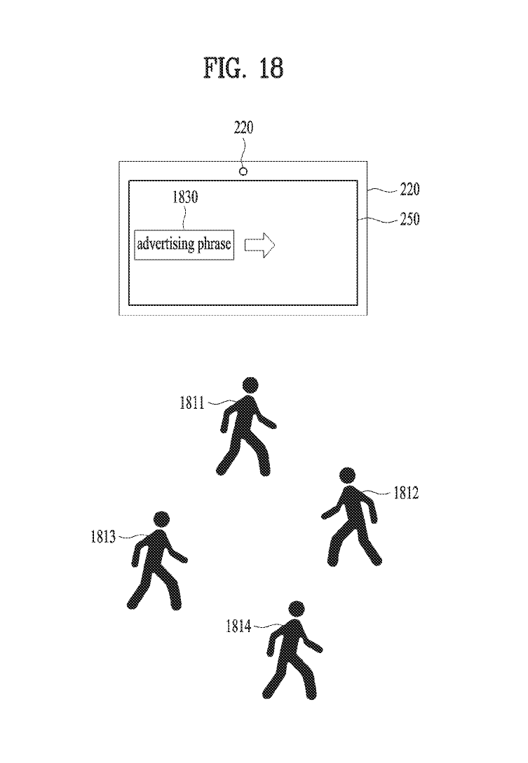

The display device 200 according to various embodiments may determine a moving direction of a pedestrian and also output a content corresponding to the determined moving direction. This is described with reference to FIGS. 17 to 19.

FIG. 17 is a flowchart of a content output operation corresponding to a pedestrian moving direction according to various embodiments of the present invention.

Referring to FIG. 17, the display device 200 may determine a moving direction of a pedestrian [S1710].

The camera 220 of the display device 200 may capture an image for pedestrian(s) moving near the display device. Based on the captured image, the controller 280 may determine a moving direction of pedestrians.

The display device 200 may output a content corresponding to the determined moving direction [S1720].

The controller 280 may output the content corresponding to the determined moving direction to the display 250. Herein, the content corresponding to the moving direction may include such a content capable of enabling eyes of a currently moving pedestrian to be maintained as a content capable of maintaining eyes of a pedestrian moving in the determined direction, a content in which a text or object moves in the same as the determined moving direction, or the like.

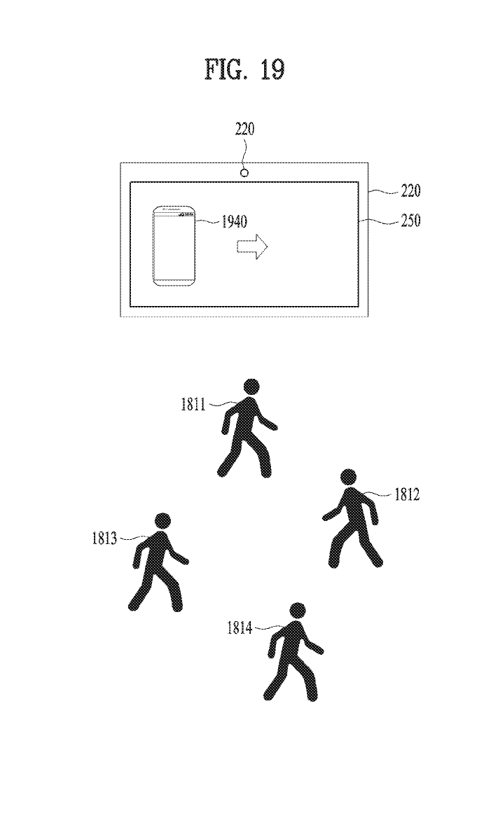

A detailed embodiment is described with reference to FIG. 18 and FIG. 19.

FIG. 18 and FIG. 19 are diagrams for examples of a content output corresponding to a pedestrian's moving direction according to various embodiments of the present invention.

Referring to FIG. 18, the camera 220 of the display device 200 may obtain an image for pedestrians 1811 to 1814 moving near the display device. Based on the obtained image, the controller 280 may determine a moving direction of each of the pedestrians 1811 to 1814. For instance, the controller 180 may determine that the first, third and fourth pedestrians 1811, 1813 and 1814 move in a right direction and also determine that the second pedestrian 1812 moves in a left direction. And, the controller 280 may determine that the number of the pedestrians moving in the right direction is greater. The controller 280 may output a content corresponding to the right direction, which is the determined moving direction, to the display 250. For instance, the controller 280 may output a content, in which an advertising text 1830 contained in the content moves in the right direction corresponding to the determined moving direction, to the display 250. Thus, the display device 200 may control the advertising text 1830 to be displayed in a manner of moving in the same as the moving direction of the pedestrians. Therefore, the display device 200 enables the moving pedestrians to pay attention to the substance of the advertising content, e.g., the advertising text.

Referring to FIG. 19, the camera 220 of the display device 200 may obtain an image for pedestrians 1811 to 1814 moving near the display device. Based on the obtained image, the controller 280 may determine a moving direction of each of the pedestrians 1811 to 1814. For instance, the controller 180 may determine that the first, third and fourth pedestrians 1811, 1813 and 1814 move in a right direction and also determine that the second pedestrian 1812 moves in a left direction. And, the controller 280 may determine that the number of the pedestrians moving in the right direction is greater. The controller 280 may output a content corresponding to the right direction, which is the determined moving direction, to the display 250. For instance, the controller 280 may output a content, in which an object 1940 contained in the content moves in the right direction corresponding to the determined moving direction, to the display 250. Herein, the object 1940 may include an object related to an advertising substance. Thus, the display device 200 may control the object 1940, which is contained in the outputted content, to be displayed in a manner of moving in the same as the moving direction of the pedestrians. Therefore, the display device 200 enables the moving pedestrians to pay attention to the substance of the advertising content, e.g., the object contained in the advertising content.

The above description is just one example for the description of a content output corresponding to a moving direction of a pedestrian, by which the present invention is non-limited. Hence, the display device 200 may display a content corresponding to a moving direction in a manner that various effects and the like move as well as an advertising text and an object. Moreover, the display device 200 may control an advertising text and/or object, which is contained in an advertising content, to be displayed in a manner of moving in a direction different from a moving direction of a pedestrian. Therefore, if the display device 200 outputs a content corresponding to a determined moving direction of a pedestrian, it may mean that a content most appropriate for the determined moving direction of the pedestrian is outputted.

Various embodiments may be implemented using a machine-readable medium having instructions stored thereon for execution by a processor to perform various methods presented herein. Examples of possible machine-readable mediums include HDD(Hard Disk Drive), SSD(Solid State Disk), SDD(Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the electronic device.

The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A display device, comprising:
a display;
a camera configured to obtain an image of a vehicle; and
a controller configured to determine a moving speed of the vehicle based on the obtained image and control an advertising content to be outputted to the display based on the determined moving speed of the vehicle.

2. The display device of claim 1, wherein if the determined moving speed is equal to or lower than a first reference speed, the controller is further configured to control a video to be outputted to the display.

3. The display device of claim 2, wherein the controller controls the video having a play time corresponding to the determined moving speed.

4. The display device of claim 1, wherein if the determined moving speed exceeds a second reference speed, the controller is further configured to control a still image to be outputted to the display.

5. The display device of claim 1, wherein if the determined moving speed exceeds a first reference speed and is equal to or lower than a second reference speed, the controller controls an image, in which a prescribed object contained in a still image moves only, to be outputted to the display.

6. The display device of claim 1, wherein the controller determines a type of the vehicle based on the obtained image and controls the advertising content corresponding to the determined vehicle type to be outputted to the display.

7. The display device of claim 1, wherein the controller determines traffic surrounding the vehicle based on the obtained image and calculates an advertisement rate for the outputted advertising content based on the determined traffic.

8. A display device, comprising:
a display;
a camera configured to obtain an image of a pedestrian; and
a controller configured to output a first content to the display, determine whether the pedestrian reacts to the outputted first content based on the obtained image, and control a second content to be outputted to the display if determining that the pedestrian reacts to the outputted first content.

9. The display device of claim 8, wherein based on the obtained image, if a moving speed of the pedestrian is reduced or the pedestrian stops moving, the controller determines that the pedestrian reacts to the outputted first content.

10. The display device of claim 8, wherein the controller determines a moving direction of the pedestrian based on the obtained image and controls content corresponding to the determined moving direction to be outputted to the display.

11. A method of operating a display device, comprising:
obtaining an image of a vehicle;
determining a moving speed of the vehicle based on the obtained image; and
outputting an advertising content based on the determined moving speed.

12. The method of claim 11, wherein if the determined moving speed is equal to or lower than a first reference speed, outputting a video.

13. The method of claim 12, comprising outputting the video having a play time corresponding to the determined moving speed.

14. The method of claim 11, wherein if the determined moving speed exceeds a second reference speed, outputting a still image.

15. The method of claim 11, wherein if the determined moving speed exceeds a first reference speed and is equal to or lower than a second reference speed, outputting an image in which a prescribed object contained in a still image moves only.

16. The method of claim 11, further comprising:
determining a type of the vehicle based on the obtained image; and
outputting the advertising content corresponding to the determined vehicle type.

17. The method of claim 11, further comprising:
determining traffic surrounding the vehicle based on the obtained image; and
calculating an advertisement rate for the outputted advertising content based on the determined traffic.

18. A method of operating a display device, comprising:
obtaining an image of a pedestrian;
outputting a first content;
determining whether the pedestrian reacts to the outputted first content based on the obtained image; and
outputting a second content if determining that the pedestrian reacts to the outputted first content.

19. The method of claim 18, wherein if a moving speed of the pedestrian is reduced or the pedestrian stops moving based on the obtained image, it is determined that the pedestrian reacted to the outputted first content.

20. The method of claim 18, further comprising:
determining a moving direction of the pedestrian based on the obtained image; and
outputting content corresponding to the determined moving direction.
